(19) United States
(12) Patent Application Publication
(10) Pub. No.: US 2010/0276080 A1
(43) Pub. Date: Nov. 4, 2010

(54) LASER WELDING METHOD

(75) Inventor: Anssi Jansson, Mikkeli (FI)

Correspondence Address: MERCHANT & GOULD PC, P.O. BOX 2903, MINNEAPOLIS, MN, 55402-0903, US

(73) Assignee: Savcor Alfa Oy, Mikkeli (FI)

(21) Appl. No.: 12/161,357

(22) PCT Filed: Jan. 19, 2007
(86) PCT No.: PCT/FI2007/000020

§ 371 Date: Jul. 20, 2010

(30) Foreign Application Priority Data
Jan. 19, 2006 (FI) 20060049

(51) Int. Cl. B29C 65/16

(52) U.S. Cl. 156/272.8

(57) ABSTRACT

The invention relates to a method for quick, flexible and quality laser welding of plastic articles. In the method, a laser beam is directed via scanner mirrors at an object being welded. According to the invention, in the method, the movement of the scanner mirrors is controlled and adjusted; and the moving speed of the laser beam is increased by increasing the focal distance to be more than 200 mm; and the moving speed of the laser beam is arranged to be more than 10 m/s; and the laser beam is moved several times along a predetermined welding track.

### FIELD OF THE INVENTION

The present invention relates to a method as defined in the preamble of claim 1 for quick, flexible and quality laser welding of articles.

### BACKGROUND OF THE INVENTION

Known in prior art are various laser welding methods. Further, known in prior art are various laser welding applications for plastic. A problem with the known laser welding applications for plastic is that their introduction as an industrial application is limited by the slowness of the methods, for example, in mass production applications as well as by the high price of laser equipment.

At present e.g. the components of mobile phones are connected to one another mainly by ultrasonic welding. The method achieves welding times of less than 0.5 seconds for the components of various sizes of mobile phones. The present laser welding methods achieve corresponding welding rates only for smaller parts such as camera lenses. For example, for the display windows of mobile phones, the welding times can be of the order of 2 to 5 seconds, which is too much in mass production applications.

A problem with the ultrasonic welding is the varying quality of the welded seam. Further, ultrasonic welding is a very complicate method, and switching from an article to be welded to another requires great mechanical arrangements in a production line. In addition, there is the problem with the various limitations in achieving welded seams of a given type.

As a laser welding method in the welding of plastics one can use continuous joint welding or scanning-type welding. In joint welding, a laser beam is moved once over a joint to be welded, like in conventional welding. In scanning-type welding, the laser beam is moved i.e. scanned several times around the joint, whereby the welded seam gets hotter and hotter after each revolution, until the entire welded seam fuses almost simultaneously. Typically, the welding speed of joint welding is less than 10 m/min, conventionally 1 to 3 m/min. The welding speed of scanning-type welding is typically 0.5 to 5 m/s. The scanning-type welding has the advantage that the air slots appearing at the welded points are filled better than in conjunction with joint welding. Using scanning-type welding one can weld up to 3 to 5 times bigger air slots than using joint welding.

Known scanners are generally used for laser marking, in which, due to the accuracy required by the marking, usually less than 20 μm, the moving speeds of the laser beam are several hundreds mm/s. Typically, the welding of plastics for the purposes of jointing does not require such a great accuracy in the moving of the laser beam, whereby one wishes to use greater speeds. However, in known devices, the maximum moving speed of a laser beam is usually in the range 5 to less than 10 m/s, which is typically the maximum speed for all focal distances.

Known scanning-type laser welding applications require about 20 to 50 scanning revolutions if there is a wish to eliminate or to significantly alleviate the measuring errors of the articles to be welded or if there is a wish to obtain a sufficiently tight joint, especially for bigger articles. With known welding speeds this is too slow. Due to this, the industry has not favored laser welding applications.

Furthermore, the known non-laser welding methods have the disadvantage that they lack flexibility, for example, when changing the article to be welded or its size.

### OBJECTIVE OF THE INVENTION

The objective of the invention is to eliminate the drawbacks referred to above.

One further objective of the invention is to disclose an improved method for flexible, quick and quality laser welding of articles. One specific objective of the invention is to disclose a method for welding big welding areas and for making the welding times shorter.

### SUMMARY OF THE INVENTION

The method of the invention is characterized by what is presented in the claims.

The invention is based on a method for quick, flexible and quality laser welding of articles. According to the invention, in the method, a laser beam is directed, via scanner mirrors, at an object being welded; the motion of the scanner mirrors is controlled and adjusted; the moving speed of the laser beam is arranged to be more than 10 m/s; and the laser beam is moved several times along a predetermined welding track.

Herein, laser welding is used to mean any kind of laser welding.

The invention is specifically based on a laser welding method in which the welding speed is very high, whereby short welding times are achieved for various and variously sized articles to be welded.

In the method of the invention, a laser beam is preferably moved several times, even 50 times, over a welded joint. By moving the laser beam tens of times over the welded joint a bigger fusion is achieved, resulting in a tighter joint.

In one embodiment of the invention, the moving times, i.e. the number of scanning times, of the laser beam along the welding track are optimized to obtain an optimal outcome. Mainly by adding to the number of scanning times one can compensate for the measuring errors in the welded joint.

In one embodiment of the invention, a program for controlling the movement of the scanner mirrors is created.

In one embodiment of the invention, a suitable lens is provided for achieving a desired optimal focal distance so that the laser beam travels through the lens and the focal distance is used to adjust the moving speed of the laser beam. Preferably, the moving speed of the laser beam is increased by increasing the focal distance. The optimum of the moving speed varies depending on the application.

In one embodiment of the invention, the method uses a focal distance of more than 100 mm. In one embodiment, the method uses a focal distance of 100 to 5,000 mm.

In one embodiment, the method uses a focal distance of more than 200 mm. In one embodiment, the method uses a focal distance of less than 1,000 mm.

Preferably, the method of the invention uses two long focal distances, more than 100 mm. However, too long a focal distance achieves an inaccurate welding outcome. Thus, the focal distance must be optimized for each case specifically.

Furthermore, the invention is based on the use of a method of the invention for laser welding of plastic articles, in which welding two plastic pieces are welded together. Previously, the laser welding of bigger plastic articles, e.g. of those having the size of a palm, has been slow, and no suitable industrial applications have been achieved. The invention achieves an industrially applicable quick laser welding method for plastic articles of various sizes.

Compared to the prior art, considerable advantages are achieved using the method of the invention.

Thanks to the invention, a very fast and flexible welding method is achieved. Thanks to the invention, it is possible to attach articles of different sizes and materials to one another. The welding times are made shorter also for bigger articles. The welding times to be achieved using the method are up to ten times faster than in the known methods. In that case, the investment in a laser apparatus per one article is an advantageous alternative. Furthermore, one laser welding apparatus in accordance with the method of the invention can replace e.g. several ultrasonic apparatuses.

Further, the invention has the advantage that when using moving speeds of a laser beam more than 10 m/s, the parameter area of the welding is increased. Furthermore, the invention makes it possible to optimize the number of moving times of the laser beam, i.e. scanning, to achieve the best outcome. In that case, the errors caused by the injection molding of plastics on the surface of plastics can be compensated by scanning the laser beam tens of times along the welding track and by pressing the articles to be welded together during the welding procedure, whereby the measuring errors become even.

Further, thanks to the invention, a tight, reliable and good-quality welded seam is obtained due to the high welding speed and nearly simultaneous welding. In addition, the quality of the welded seam is easy to monitor.

Further, thanks to the laser welding method in accordance with the invention, switching from one product to another in a production line is easy just by changing the program. As a main rule, one does not need to do any mechanical changes to the apparatus in the method of the invention. Thus, the introduction of new products into the production line is made faster.

In addition, the method of the invention makes it possible to weld several articles at the same time.

The method of the invention is applicable for use in the welding of various materials in an industrial scale, for example, in the welding of various plastic articles in the mobile phone industry. In addition, the method can be applied in the manufacture and marking of any products for which laser welding can be used.

### LIST OF FIGURES

In the following section, the invention will be described in detail with reference to the accompanying drawings, in which

FIG. 1 illustrates the principle of scanning-type welding; and

FIG. 2 describes the effect of the increase of the focal distance on the area to be welded as well as on the welding speed.

### DETAILED DESCRIPTION OF THE INVENTION

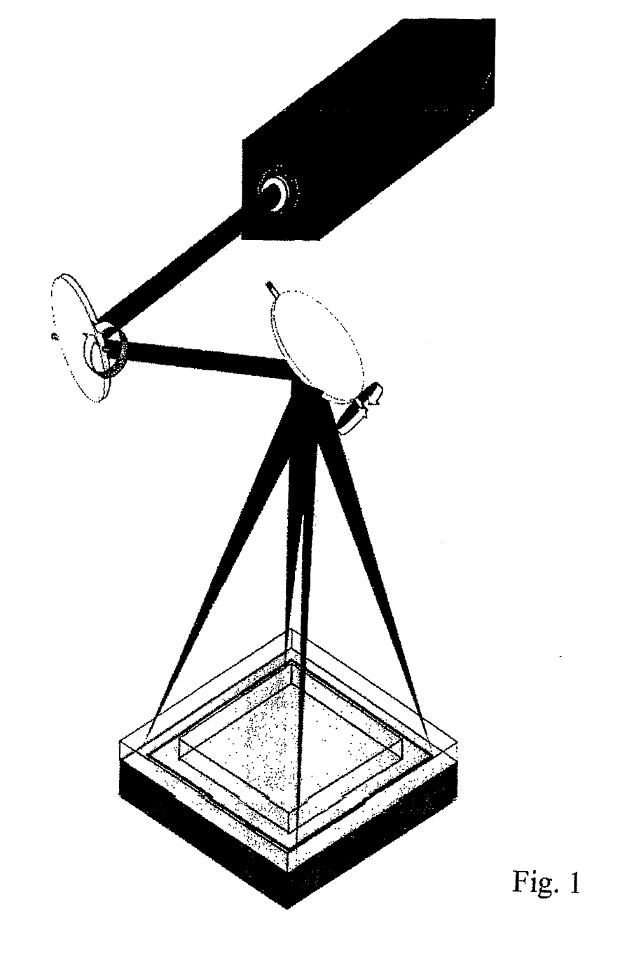

The method of the invention was tested in the welding of plastics using a scanner (FIG. 1) known from laser marking. In this technology, a laser beam is scanned at a high speed by means of galvo mirrors several times over a welding geometry. Due to the low thermal conductivity of plastics, the welded joint to be formed gets gradually hotter and relatively uniformly such that the entire welded joint fuses almost simultaneously. In the method, the welding time is determined by the welding speed i.e. the scanning speed used, the number of scanning times used as well as by the size of the article. The welding track that forms the welded joint can be created e.g. based on a CAD image.

The speed and the working area of a scanner used in scanning-type welding are determined by the optics used. For example, a known diode laser apparatus which was used in one test achieved a working area of 100 mm×100 mm when a focal distance of 160 mm was used, in which working area the size of a focal point i.e. the width of the weld was 1.1 mm. When the focal distance was made longer, both the size of the working area and the size of the focal point increased linearly. For example, with a focal distance of 430 mm, the working area was about 300 mm×300 mm and the size of the focal point was 2.7 mm. Due to the big focal point, the diode laser welding of plastics has not heretofore used large working areas. One test using a novel fiber laser achieved small sizes of focal points also for large working areas; with a focal distance of 300 mm, the working area was 200 mm×200 mm and the size of the focal point was 0.15 mm, for example.

The angle of the scanner mirrors can be adjusted automatically, depending on the geometry of the object to be welded, on the welding area and on the width of the seam, etc.

In this connection, welding speeds of more than 10 m/s were examined, and the results obtained based on these were compared to the results obtained using a typical speed of 2 to 5 m/s. As the number of scanning times, 30 to 50 times per welded seam was used. The welded seam increased at every scanning time.

The tests used various focal distances to increase the welding speed. For example, focal distances of 100 mm, 200 mm and 500 mm were tested.

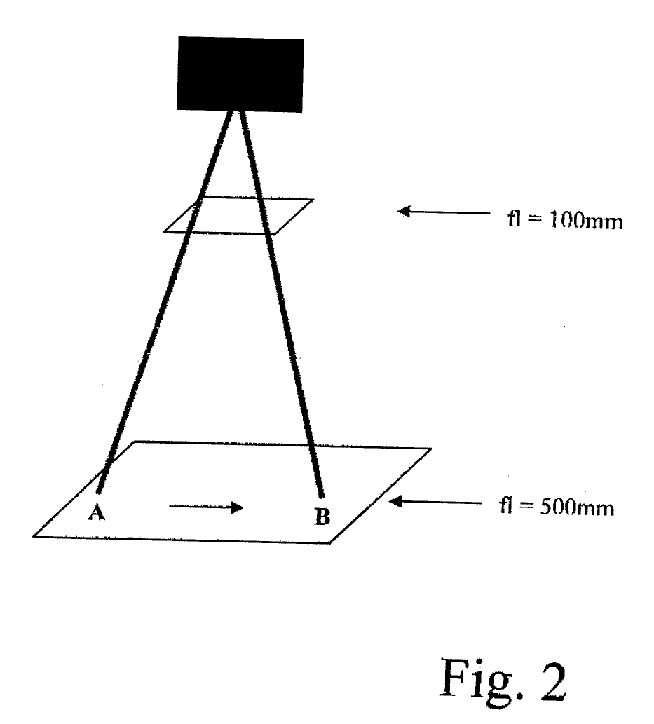

In the tests made it was found out that with longer focal distances, the laser beam can be moved at higher speeds than with shorter focal distances. The moving speed of a laser beam can be affected by the speed of the scanner mirrors. With a focal distance of 100 mm, the maximum speed was V m/s and with a focal distance of 500 mm, the maximum speed was 5 times V m/s (FIG. 2). Thus, the laser beam travels from point A to point B within the same time when using both a short and a long focal distance, but a longer stretch when using a long focal distance.

In the test made it was found out that the moving speed of a laser beam can be increased even up to 50 to 100 m/s by increasing the focal distance. However, the increase of the moving speed in relation to the increase of the focal distance must be optimized because the welding accuracy of the scanners used becomes a limiting factor. As a main rule, the accuracy of scanners is impaired in the same ratio as the focal distance increases. With a focal distance of 500 mm, the accuracy is 5 times poorer than with a focal distance of 100 mm.

In the tests made, for example, a welded seam of 150 mm could be welded in 0.75 seconds using the scanning-type welding of the invention when as the welding speed, 10 m/s was used and the welded seam was scanned 50 times. Similarly, a similar welded seam could be welded in 0.3 seconds when as the welding speed, 25 m/s was used and the number of scanning times was 50. The corresponding welding times with the previously known methods were 3 and 1.5 seconds when as the welding speed 2.5 m/s and 5 m/s were used.

In using known scanners one has to create a new program in the scanner for raising the welding speed to be more than 10 m/s, for enabling the use of a longer focal distance as well as for controlling the movement of the scanner mirrors. In one embodiment, the change of program is implemented so that the maximum moving speed of the laser beam is dependent on the scanner mirrors and the focal distance used. In that case, moving speeds of about 50 m/s are obtained using a focal distance of 500 mm.

The scanning device i.e. scanner designed for laser welding is known per se in structure and functions in a manner known per se and is therefore not described in greater detail herein. The laser welding is performed in a manner known per se and is therefore not described in greater detail herein.

In the form of various embodiments, the method of the invention is suited for the laser welding of most versatile articles.

The invention is not limited merely to the examples referred to above, but many modifications are possible within the scope of the inventive idea defined by the claims.

1. A method for laser welding plastic articles, in which a laser beam is directed via scanner mirrors at an object being welded, wherein in the method, the movement of the scanner mirrors is controlled and adjusted and the moving speed of the laser beam is increased by increasing the focal distance to be more than 200 mm; and the moving speed of the laser beam is arranged to be more than 10 m/s; and the laser beam is moved several times along a predetermined welding track.

2. The method as defined in claim 1, wherein the times of moving the laser beam along the welding track is optimized.

3. The method as defined in claim 1 wherein a program is created for controlling the movement of the scanner mirrors as well as for using a longer focal distance.

4. The method as defined in claim 1 wherein the maximum moving speed of the laser beam is dependent on the scanner mirrors and the focal distance to be used.

5. The method as defined in claim 1, wherein a suitable lens is provided for obtaining the desired optimal focal distance so that the laser beam travels through the lens, and the focal distance is used to adjust the moving speed of the laser beam.

6. The method as defined in claim 1, wherein the method uses a focal distance of less than 5,000 mm.

7. The method as defined in claim 1, wherein the method uses a focal distance of less than 1,000 mm.
